(19) United States
(12) Patent Application Publication
(10) Pub. No.: US 2007/0221513 A1
(43) Pub. Date: Sep. 27, 2007

(54) DUAL CONTAINERS HAVING MECHANISM FOR MIXING AND SEPARATING CONTENTS OF CONTAINERS

(76) Inventors: KEITH TAYLOR-SHARP, MINNEAPOLIS, MN (US); HAROLD LEIGHTON, BOCA RATON, FL (US); MAXINE LEIGHTON, BOCA RATON, FL (US)

Correspondence Address: DANIEL S. POLLEY, P.A., 1215 EAST BROWARD BOULEVARD, FORT LAUDERDALE, FL, 33301, US

(21) Appl. No.: 11/612,283

(22) Filed: Dec. 18, 2006

Related U.S. Application Data
(60) Provisional application No. 60/785,245, filed on Mar. 23, 2006.

(51) Int. Cl. B65D 25/08; B67D 5/56

(52) U.S. Cl. 206/219; 222/129

(57) ABSTRACT

Dual containers having a valve mechanism that cuts off or provides communication between their internal areas to store and separate different content from each other until it is desired to mix the two contents together. A first valve embodiment incorporates a push/pull configuration, which is pulled to an opened position for allowing the two previously separated contents to be mixed together. In a second valve mechanism embodiment a twist configuration is provided. Thus, when the first container is turned to a certain position a through aperture of the first container can be aligned with a through aperture of the second container. In third valve mechanism a blocking member assembly and positioning lever is provided with each container secured to the blocking member assembly. An outlet can be provided on either container for exiting the mixed contents.

This application claims the benefit of and priority to U.S. application Ser. No. 60/785,245, filed Mar. 23, 2006, which is incorporated by reference in its entirety

### FIELD OF INVENTION

The present invention relates generally to containers and more particularly to a dual container having a mechanism for isolating/separating and mixing the contents of both containers.

### BACKGROUND OF INVENTION

There are many items such as drinks, cosmetic & beauty products, food items, medical products and applications, household & industrial products, retail products, etc. that involve combining two contents where preferably the two contents are kept separated and mixed just prior to application or consumption of the item. Often the separated components are sold individually and not as a unit with both contents then poured into another container, cup, bottle, receptacle, vessel, etc. (all collectively referred to as “container” or “containers”) for mixing together. This often results in a spill to occur of one or more of the contents and also often requires the user to decide how much of each content to use in the mixture. Certain solutions and mixtures need to be protected from contamination. Thus, what is needed is a device which can hold and keep two components, contents, materials, ingredients, liquids, etc. (all collectively referred to as “content” or “contents”) separated and then permit the separated contents to be mixed together prior to consumption or application. It is therefore to these intended objects that the present invention is directed.

### SUMMARY OF THE INVENTION

The present invention generally provides dual containers having a valve mechanism that cuts off or provides access and communication between the internal areas of the dual containers. In a first valve mechanism embodiment a push/pull configuration is provided, wherein in a valve closed position the internal area of the first container is not in communication with the internal area of the second container, thus the contents stored in each internal area are kept isolated or separated from each other. When it is desired to mix the stored contents of the two containers together the valve is pulled to an opened position allowing the two stored contents to meet and be mixed together. An outlet can be provided on either or both containers for exiting the mixed contents.

In a second valve mechanism embodiment a twist configuration is provided. Thus, when the first container is turned to a certain position the flow or through aperture of the first container can be aligned with a flow or through aperture of the second container. This causes communication to exits between the respective container internal areas, thus, allowing the previously isolated stored contents to meet and be mixed together. An outlet can be provided on one or both containers for exiting the mixed contents. In a valve closed position, the two flow apertures are not aligned with each other thus cutting off communication between the respective container internal areas.

In a third valve mechanism a blocking member assembly and lever is provided with each container secured to the blocking member assembly. Turning the lever causes a ball or plate to either open or close which determines whether the valve is an opened or closed position.

The invention is not considered limited to any particular shapes or configurations for the containers. Additionally, the content(s) stored within the internal areas of the containers is not considered limited to any particular item. Thus, with the present invention two contents can be conveniently stored and isolated from each and mixed valve is preferably internally located all mixing is conducted internally within the containers, which greatly reduces, if not eliminates potential messes since spilling during mixing is a not an issue.

### BRIEF DESCRIPTION OF THE DRAWINGS

FIG. 1 is a perspective view of the present invention incorporating a first embodiment for the separating/mixing mechanism;

FIG. 2 is a perspective view of the first embodiment of the invention using different style containers and sizes. This unit also illustrates an application brush, sponge cap, nozzle etc. that may or may not be needed for various applications and can be included with any of the containers of the present invention.

FIG. 3 is a sectional view of the first embodiment separated/mixing mechanism shown in an open mixing position;

FIG. 4 is a sectional view of the first embodiment separating/mixing mechanism of FIG. 3 shown in a closed blocking configuration;

FIG. 5 is a perspective view of the present invention incorporating a second embodiment separating/mixing mechanism;

FIG. 6 is an exploded view of the present invention with the second embodiment separating/mixing mechanism and showing a non-limiting removable base unit that can be used as a dish, bowl, cup, mug, etc. for the final mixture. The removable base can be used with any of the containers of the present invention.

FIG. 7 is a perspective view of the present invention incorporating a third embodiment separating/mixing mechanism;

FIG. 8 is a perspective view of the invention shown in FIG. 7 with one container removed to reveal a first version of the third embodiment separating/mixing mechanism shown in an open mixing configuration;

FIG. 9 is a perspective view of the invention shown in FIG. 7 with one container removed to reveal a first version of the third embodiment separating/mixing mechanism shown in a closed blocking configuration;

FIG. 10 is a perspective view of the invention shown in FIG. 7 with one container removed to reveal a second version of the third embodiment separating/mixing mechanism shown in an open mixing configuration;

FIG. 11 is a perspective view of the invention shown in FIG. 7 with one container removed to reveal a second version of the third embodiment separating/mixing mechanism shown in a closed blocking configuration;

FIG. 12 is a side partial sectional view of a preferred embodiment for the push pull valve for the dual container in accordance with the present invention shown in a valve opened position;

FIG. 13 is a side partial sectional view of the preferred push pull valve dual container of FIG. 12 shown in a valve closed position;

FIG. 14 is a perspective sectional view of the dual container of FIG. 12 shown in a valve opened position;

FIG. 15 is a perspective sectional view of the dual container of FIG. 12 shown in a valve closed position;

FIG. 16 is a sectional perspective view of the preferred push pull valve embodiment shown in a valve opened position;

FIG. 17 is a sectional perspective view of the preferred push pull valve embodiment shown in a valve closed position;

FIG. 18 is perspective view of the second valve section for the preferred push pull valve of FIG. 12;

FIG. 19 is top view of the second valve section for the preferred push pull valve of FIG. 12;

FIG. 20 is side sectional view of the second valve section for the preferred push pull valve of FIG. 12;

FIG. 21 is a perspective view of the first valve section for the preferred push pull valve of FIG. 12;

FIG. 22 is an exploded view of the preferred push pull valve dual container of FIG. 12;

FIG. 23 is a perspective view of a dial member in accordance with the dual container of FIG. 12;

FIG. 24 is an exploded perspective view of the preferred twist valve dual container in accordance with the present invention;

FIG. 25 is a front sectional view of the preferred twist valve dual container of FIG. 24 shown in a valve opened position;

FIG. 26 is a front sectional view of the preferred twist valve dual container of FIG. 24 shown in a valve closed position;

FIG. 27 is a perspective sectional view of the preferred twist valve dual container of FIG. 24 shown in a valve opened position;

FIG. 28 is a perspective sectional view of the preferred twist valve dual container of FIG. 24 shown in a valve closed position;

FIG. 29 is an exploded sectional view of the preferred twist valve dual container of FIG. 24;

FIG. 30 is a top view of the first container for the preferred twist valve dual container of FIG. 24;

FIG. 31 is a side view of the first container of FIG. 30;

FIG. 32 is a bottom view of the first container of FIG. 30;

FIG. 33 is a sectional view of the first container of FIG. 30;

FIG. 34 is a perspective view of the first container of FIG. 30;

FIG. 35 is a top view of the second container for the preferred twist valve dual container of FIG. 24;

FIG. 36 is a side view of the second container of FIG. 35;

FIG. 37 is a sectional view of the second container of FIG. 35;

FIG. 38 is a perspective view of the second container of FIG. 35;

FIG. 39 is a sectional closed view of the preferred twist valve for the dual container of FIG. 24 shown in a valve closed position; and

FIG. 39 is a sectional closed view of the preferred twist valve for the dual container of FIG. 24 shown in a valve opened position.

### DETAILED DESCRIPTION OF THE DRAWINGS

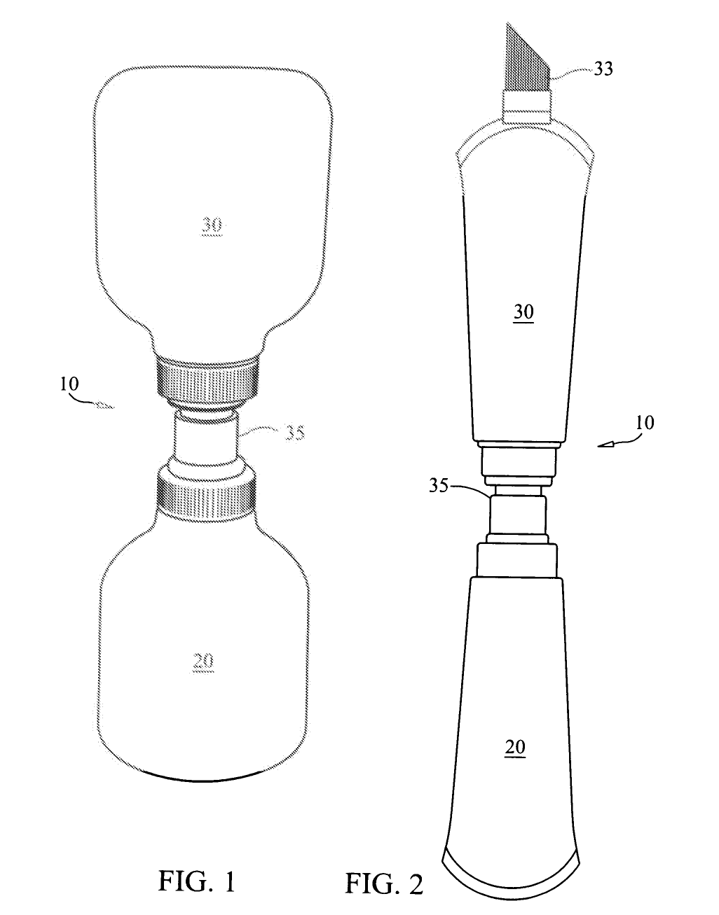

Seen in FIGS. 1 through 4 the present invention is shown with dual containers and a first embodiment separating/mixing mechanism and is generally referenced as device 10. Device 10 includes a first container 20 and a second container 30 which are either isolated from or in communication with each other through a first embodiment separating/mixing mechanism 35. As seen in FIGS. 1 and 2 the shapes and sizes of the containers 20 and 30 are not limited to any particular shape or size and all are considered within the scope of the invention. There is also no limitation for the shape and size of the containers with respect to the other separating/mixing embodiments of the present invention.

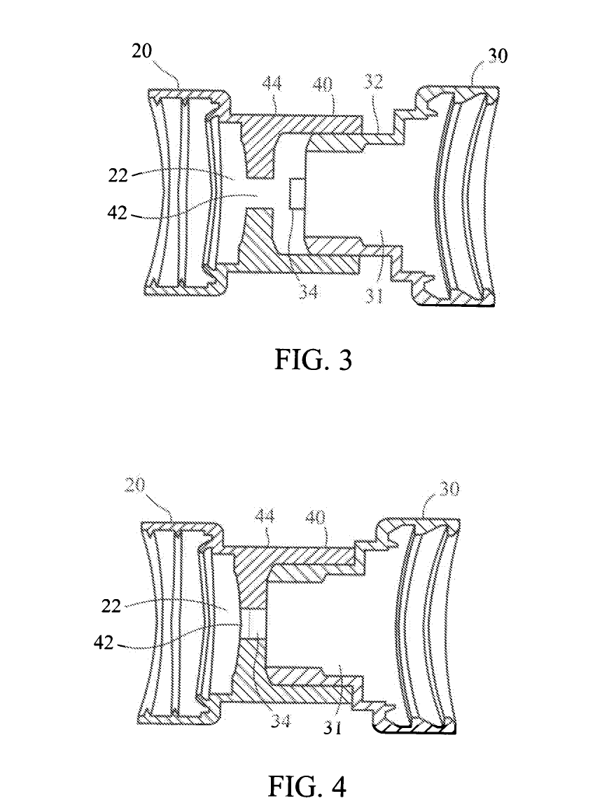

In the first embodiment, separating/mixing mechanism 35 can be a push-pull device similar to push-pull mechanisms found on water bottles. As best seen in FIGS. 3 and 4, container 20 includes an opening 22 and container 30 includes an opening 31 defined by wall 32. Container 30 also includes a blocking member 34. Containers 20 and 30 can be connected to each other, either permanently or removably, through an intermediate member 40 having opening 42 and a wall 44. As seen in FIG. 4, to isolate the internal area and contents of container 20 from the internal area and contents of container 30, blocking member 34 is disposed within opening 42 of intermediate member 40 which causes a seal and separation between the internal areas of containers 20 and 30. Where it is desired to provide communication between containers 20 and 30 and thus to mix the contents of both containers together, container 30 is slid along wall 44 causing blocking member 34 to leave is position within opening 42 (See FIG. 3) and thus provide communication between the internal areas of both containers to allow the contents of one container to flow into the other container through openings 22 and 31. It should be recognized that container 20 can be provided with the wall and blocking member and thus the operation roles of containers 20 and 30 in separating and mixing the stored contents would be reverses as described above.

In all embodiments of the invention, the subject matter of the contents residing in either container 20 and/or 30 is not considered limited to any particular composition, matter, item, liquid, material, etc. As seen in FIG. 2, device 10 can be used for hair application or other types of applications requiring the use of a brush, sponge, nozzle, cap, etc. (collectively referred to as “brush”). In this configuration communication between a brush 33 and the contents of the internal area of container 30 (though also container 20 could be used) can be provided such that the mixed content residing in container 30 is permitted to flow through to brush 33 for its desired application. Internal communication for sending the contents from the internal area of container 30 to brush 33 can be provided, and can be, but is not limited to, through a conduit, passageway etc. A brush, sponge, nozzle, cap, etc. can be used with any of the containers of the present invention.

Though not shown, where a brush is provided with one of the containers of the present invention, there can also be provided a device, such as, but not limited to, a tap member to stop the flow of product or capture the product until the user needs the product to flow to the brush. In one non-limiting embodiment, a membrane (similar to a shoe scuff remover) can be provided as the product flow stopper, especially where the container is used with a brush or sponge. Where a nozzle is provided at the end of container, accessing the mixed contents can be similar to a tube of glue or caulking, where the tip or end portion of the nozzle is cut away to allow the substance to flow. Other flow stopping mechanisms can be used and are all considered within the scope of the invention.

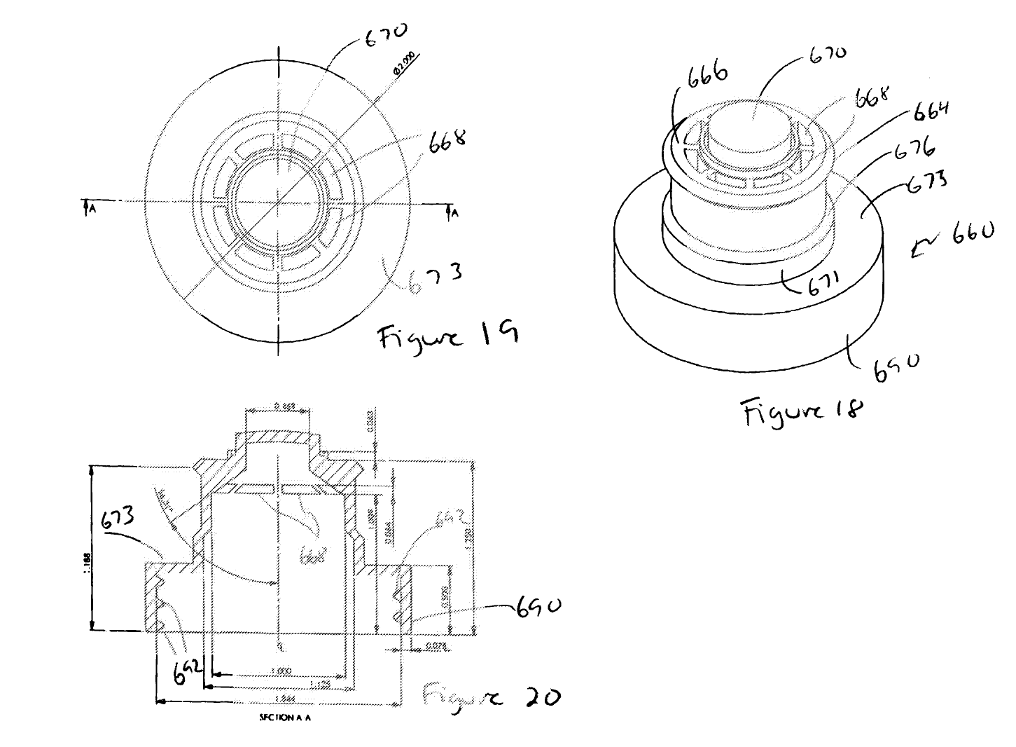

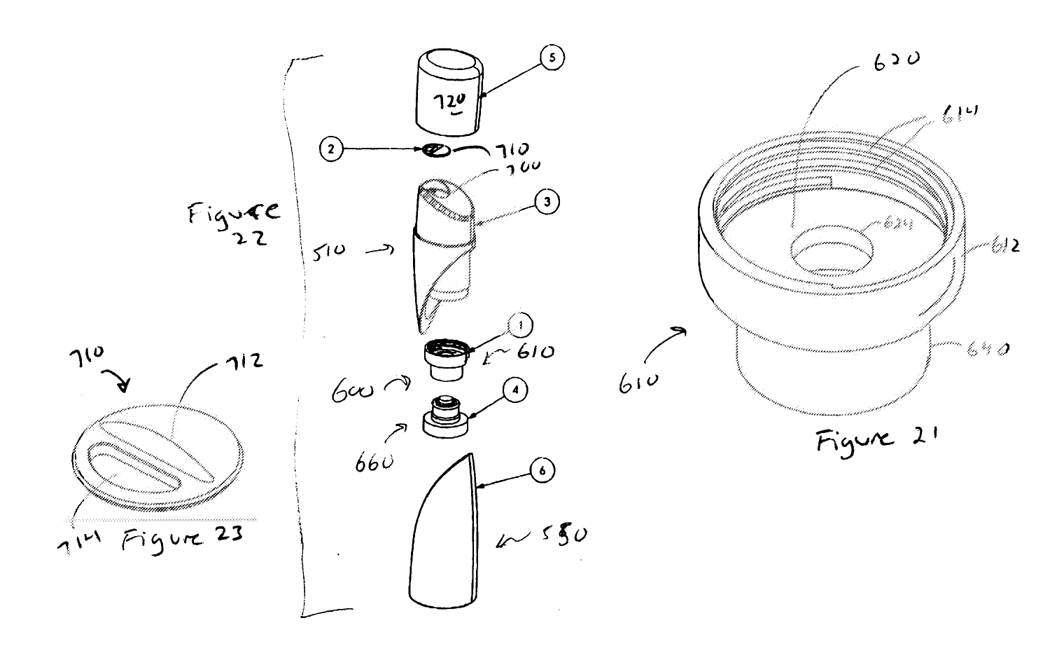

FIGS. 12-23 illustrate in more detail the preferred push/pull valve mechanism for the first embodiment, which is generally shown as valve 600 for dual container device 500. Device 500 generally contains a first container 510 and a second container 550 connected to and in communication with each other through push/pull valve 600. Valve 600 comprises a first member 610 and a second member 660.

First member 610 includes a base 612 which is connected to a portion 580 of first container 510, preferably, though not limiting, through complimentary grooves 582 and 614. Other fastening mechanisms for securing first member 610 to first container 510 can also be used and are considered within the scope of the invention. Base 612 terminates to a second horizontal portion 620, which is oriented somewhat perpendicular to base 612, though doesn't necessarily have to be exactly perpendicular. Second portion 620 defines an aperture 624, which can be preferably centrally located. A first surface 630 of second portion 620 can be provided within a groove or slot 632 which creates an outer sidewall 633. Preferably groove 632, sidewall 633 can be circular in shape and extends around aperture 624. A flange 640 preferably extends downward with respect to and from second portion 620 and can be somewhat perpendicular to second portion 620, though doesn't necessarily have to be exactly perpendicular. Preferably, flange 640 and base 612 are circular in shape. Flange 640 is provided with inner protrusion 644 which can also be preferably circular. Preferably, all of the described portions of first member 610 are monolithically formed/constructed integral together.

Second member 660 includes a base 690 which is connected to a portion 540 of second container 550, preferably, though not limiting, through complimentary grooves 542 and 692. Other fastening mechanisms for securing second member 660 to second container 550 can also be used and are considered within the scope of the invention. Base 690 terminates to a second horizontal portion 673, which is oriented somewhat perpendicular to base 690, though doesn't have to be exactly perpendicular. A first sidewall 671 extends upwards from base 690, and can be somewhat perpendicular to base 690, though doesn't necessarily have to be exactly perpendicular. A first ledge 676 preferably extends inward and can be either substantially horizontal or angled inward from first sidewall 671. Second sidewall 662 extends upward from first ledge 676 and can be somewhat parallel with first sidewall 671, though doesn't necessarily have to be exactly parallel. An outward extending protrusion 664 is provided at the top of second sidewall 662. Second sidewall 662 terminates into a top member 666. Top member 666 defines one or more, and preferably a plurality of, apertures 668 extending through top member 680 and providing access to internal area of second valve member 660 and ultimately to the internal area of second container 550 to which second valve member 660 is secured to.

An insertion member 670 protrudes upward from top member 666 and can be preferably centrally located with respect to top member 666, though such is not considered limiting. Preferably, top member 666 can be provided within a groove or slot 675 which creates an outer sidewall 677. Preferably groove 675, sidewall 677 can be circular in shape and extends around insertion member 670.

First valve member 610 is secured to second valve member 660 by disposing protrusion 644 between ledge 676 and protrusion 664 at the top of sidewall 662, which causes protrusion 664 to be disposed between protrusion 644 and undersurface 630 of first valve member 610. Thus, a travel route 674 along sidewall 662 of second valve member is provided for protrusion 644 between ledge 676 and protrusion 664.

When valve 600 is in its fully open position, the contents of first container 510 is permitted to enter aperture 624 of first valve member 610 and then one or more apertures 668 of second valve member 660 wherein it ultimately the internal area of second container 550 and mixes with the contents contained in the second container. It should be recognized that valve 600 can also be disposed in a partially opened position, through the positioning of protrusion 644 intermediate between ledge 676 and protrusion 664.

When valve 600 is in its fully closed and sealed position the first contents is contained and stored within the first internal area of container 510. As seen insertion member is snugly received within aperture 624 to block the contents of first container 510 from escaping from within first container 510. Valve 600 can be further sealed through the mating relationship of groove 632/sidewall 633 of first valve member 610 with groove 675/sidewall 677 of second valve member 660. A further seal can be provided through the abutment of undersurface 630 with top member 666, which also closes off access to apertures 668.

An outlet or content exit can be contained in at least one of the containers and is shown generally incorporated into first container 510, though such is not considered limiting. Though a multitude of various outlets, brushes, can be provided within the containers for exiting the mixed content, and open/close outlet 700 is shown. Wherein, an area 702 is provided within container 510 and has an opening 704. A rotatable dial 710 can be inserted into and retained at area 702. Dial 710 includes a handle 712 and has an opening 714, which can be similar in shape to opening 704, though such is not considered limiting or absolutely necessary. When withdrawing the mixed contents, dial 710 can be turned or rotated such that opening 704 and opening 714 are at least partially aligned, which causes the mixed content to be exited out of area 702. Prior to withdrawing the mixed content, dial 710 is positioned such that its non-opening portion 716 cover opening 704 and prevents any of the content from escaping out of area 702.

A cap 720 can also be provided, which can serve as a cup or vessel for pouring the mixed contents. Cap 720 can be removably positioned on container 510 and can cover area 702 when secured to container 510. It should be recognized that cap 720 can also be positioned on container 550.

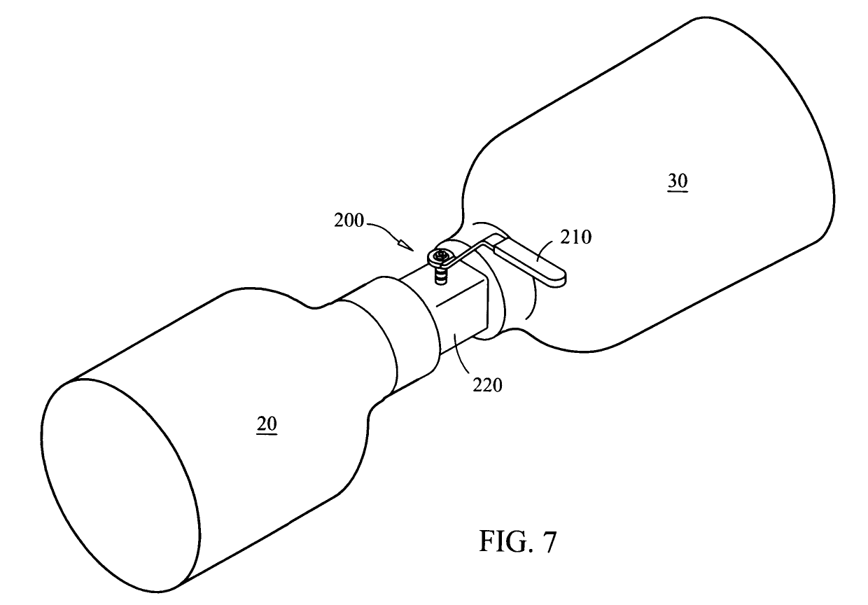

As best seen in FIG. 6 in discussion with a second embodiment for the separating/mixing mechanism, either or both of the containers 20 and/or 30 can be provided with a removal bottom to provided access to the mixed contents of containers 20 and 30. The removable bottom portion can be used with all embodiments and containers of the invention and all are considered within the scope of the invention. Thus, where container 30 holds a serving of milk and container 20 holds a portion of cereal, with a removable bottom portion 21, the cereal and milk can mixed in bottom portion 21 (having a wide opening) where it can be easily accessed through a spoon or other eating utensil. Thus, removable bottom portion 21 can serve as a base, dish, mug, bowl, cup, etc., and can be attached, removed and sealed to the remaining portion of its associated container by any know or later developed techniques. The various uses for removable bottom portion 21 are not limited to any particular purpose and all are considered within the scope of the invention.

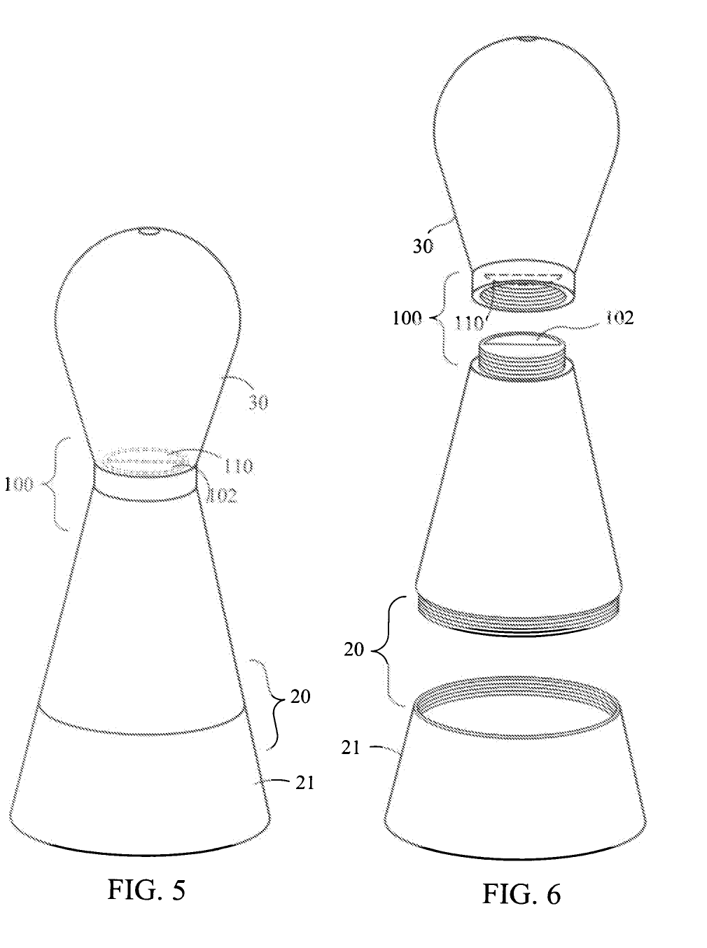

As seen in FIGS. 5 and 6, a second embodiment for the separating/mixing mechanism is shown and generally reference 100. Mechanism 100 includes a first aperture 102 associated with container 20 and a second aperture 110 associated with container 30. In one non-limiting embodiment, apertures 102 and/or 110 can be substantially semi-circled in shape. Device 10 with mechanism 100 can be positioned in a separated/blocking configuration by screwing container 30 to container 20 or otherwise attaching container 30 to 20 (snug relationship) such that apertures 102 and 110 are not fully aligned or partially aligned (FIG. 5). Thus, in this configuration there is no internal communication between container 20 and container 30. To allow mixing of the stored contents within container 20 and container 30, either container 30 or 20 is turned such that apertures 102 and 10 are fully or partially aligned with each other to provide internal communication between containers 20 and 30 and allow the contents of containers 20 and 30 to be mixed or otherwise brought together.

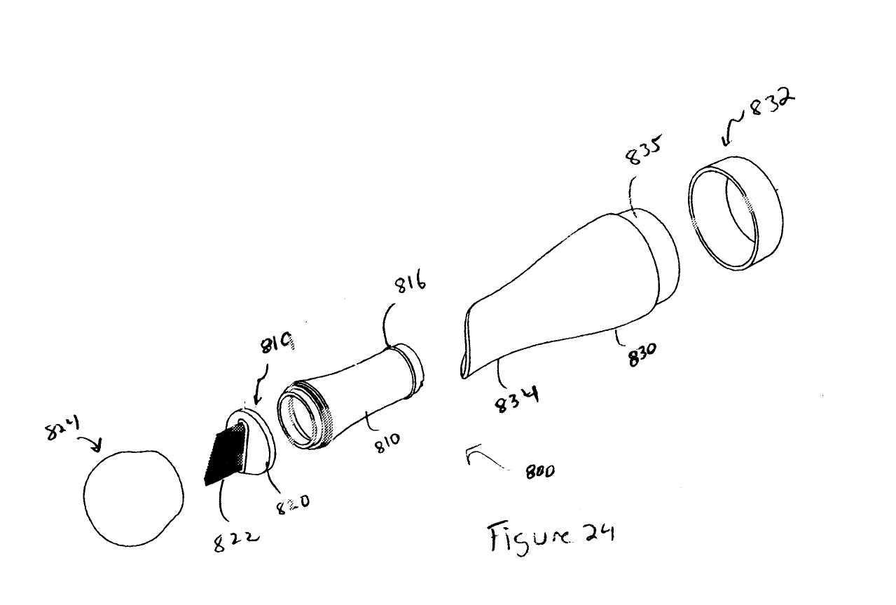

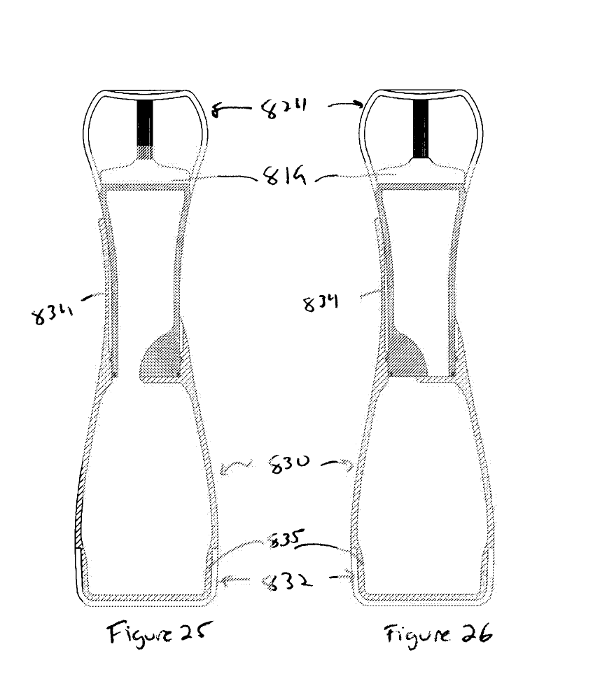

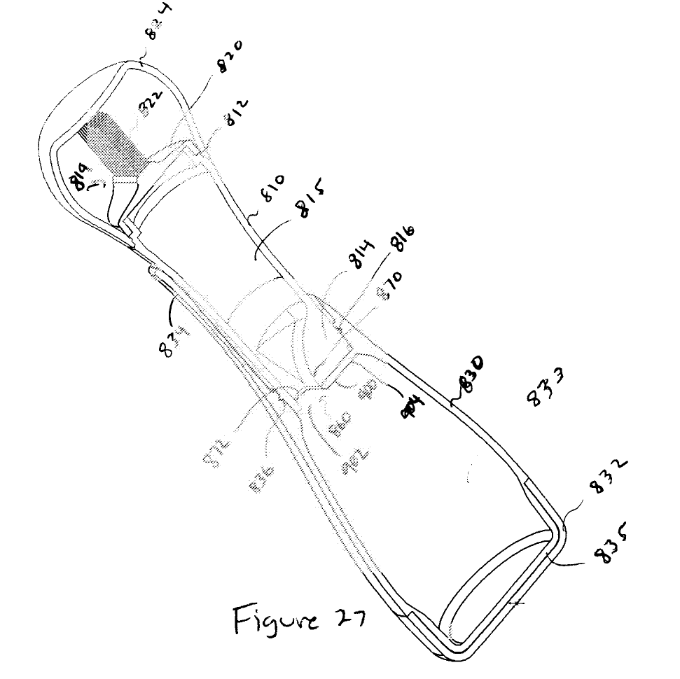

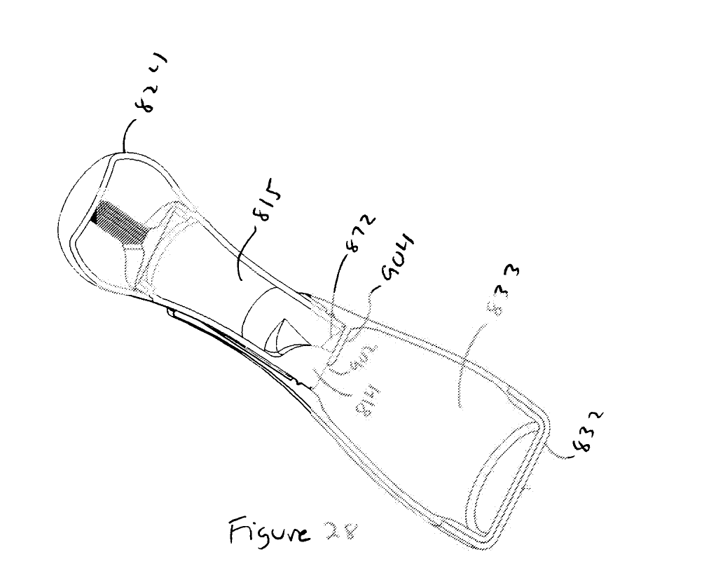

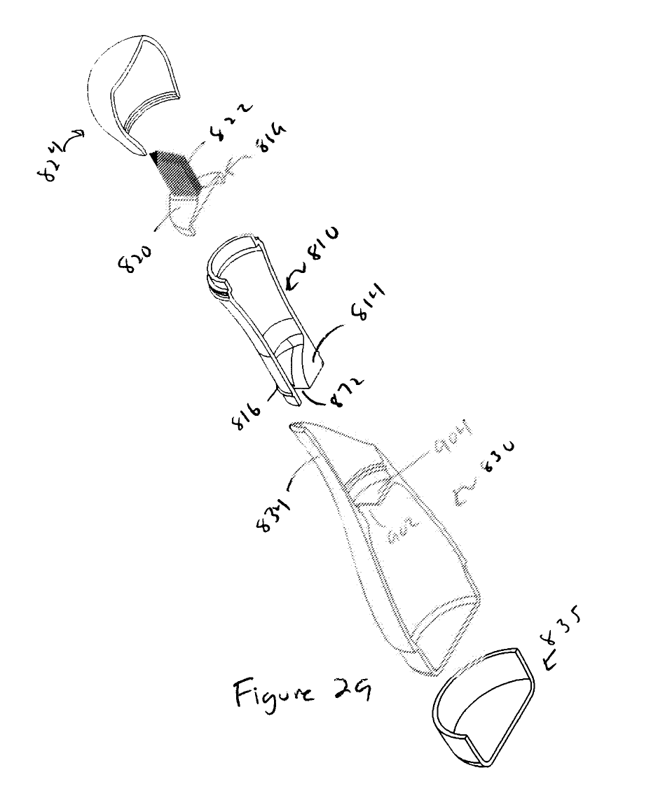

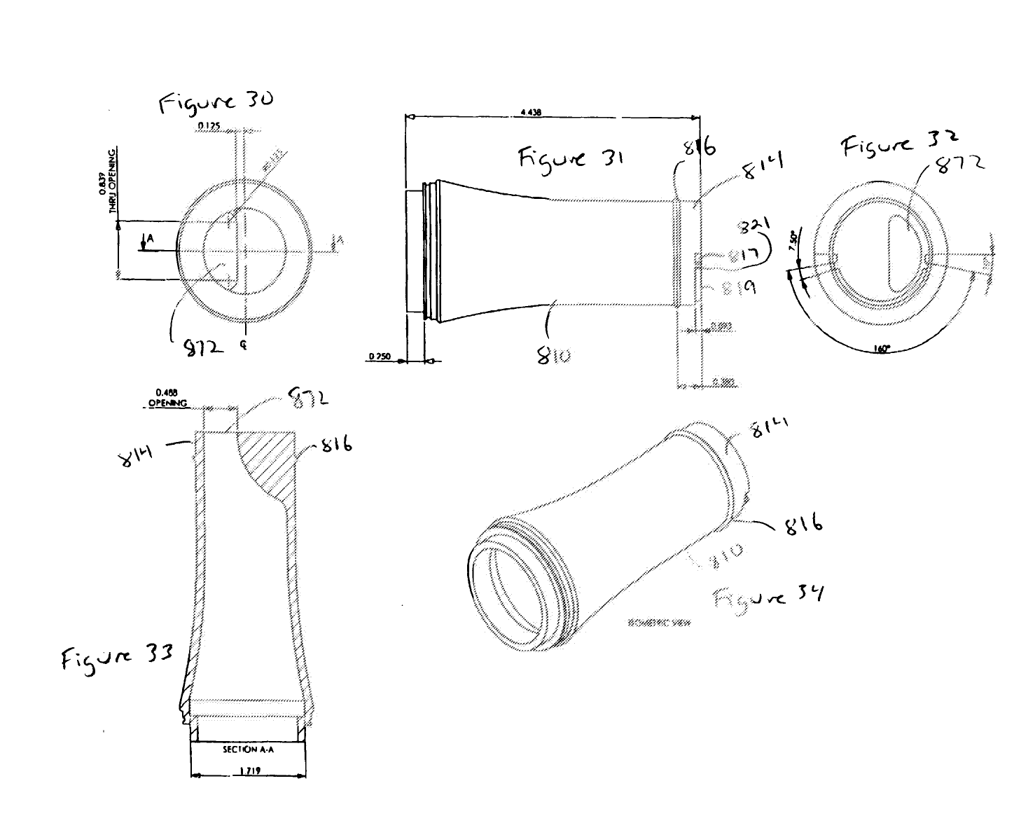

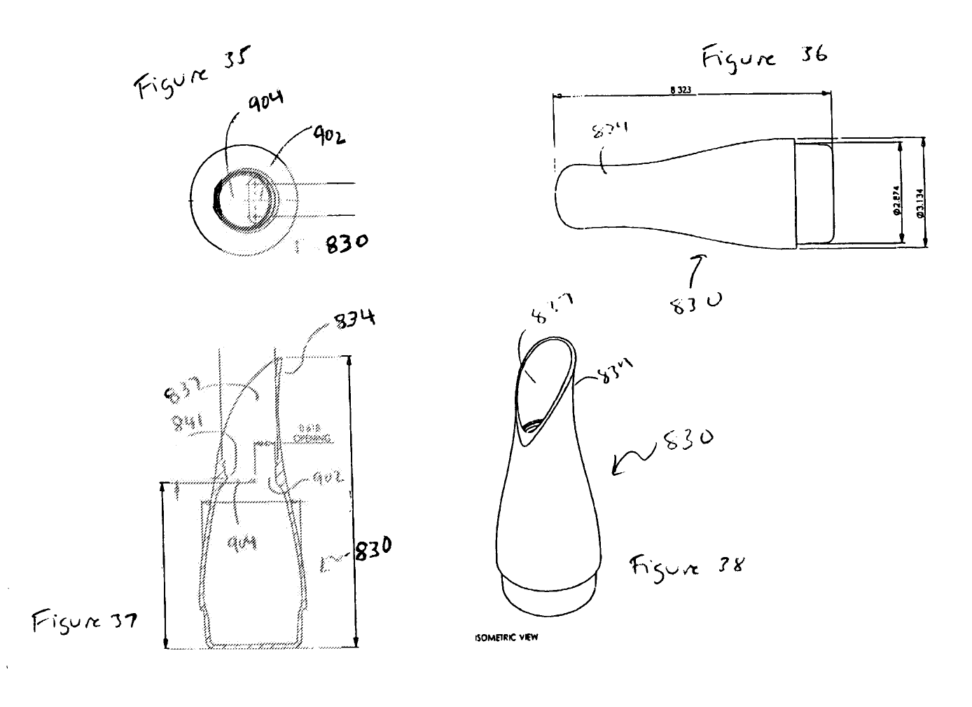

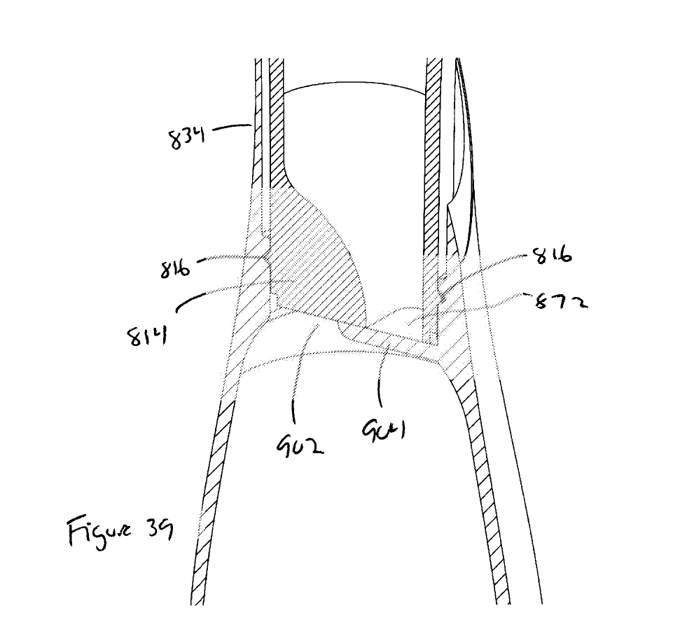

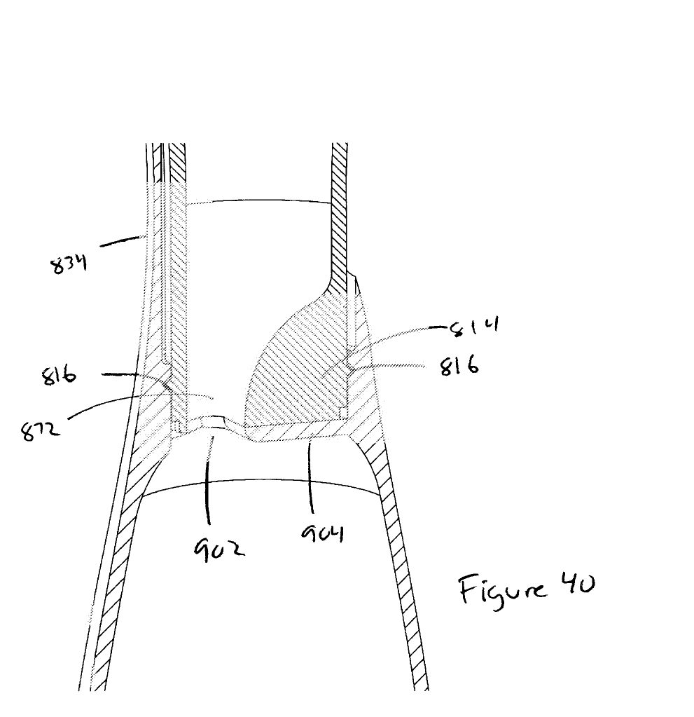

FIGS. 24-40 illustrate in more detail the preferred twist valve mechanism for the second embodiment which is generally shown as valve 860 for dual container device 800. Device 800 generally contains a first container 810 and a second container 830 connected to and/or in communication with each other through twist valve 860. Valve 860 comprises a first member 870 which can be incorporated into (or formed as part of) first container 810 and a second member 900 which can be incorporated into (or formed as part of) second container 830.

First valve member 870 can comprise a cutout or opening 872 at the lower portion 814 of first container 810. A circular groove or protrusion 816 can be provided on the outside of lower portion 814 and serves as a directional and/or securing thread when received within groove 836 of second container 830. Second valve member 900 can comprise a cutout or opening 902 and ledge 904 at an intermediate area of second container 830. Second container 830 also includes a top portion 834 which defines a channel 837 for receipt of first container 810.

In use first container 810 is positioned within channel 837 preferably with thread 816 disposed within groove 836. In a closed/sealed position, opening 872 is positioned over ledge or surface 904, which prevents any of the contents contained within internal area 815 of first container 810 from traveling through opening 872 and entering into second container 830.

An inner protrusion 841 can be provided within second container 830 for mating with either aperture 817 or track 819 defined by or disposed at bottom portion 814 of first container 810. Track 819 defines and/or limits the amount of rotation of first container 810 with respect to second container 830, when received within channel 837. When protrusion 841 of second container 830 reaches the end of track 819 opposite of aperture 817, openings 872 and 902 can be fully aligned. When protrusion 841 is disposed within aperture 817, opening 872 can be fully sealed and disposed over ledge or surface 904 of second container 830. Thus, when protrusion 841 is disposed within aperture 817, first container 810 can be considered to be in a locked position within respect to second container 830. A certain amount of turning force can be required to be exerted on first container 810 or second container 830 in order to overcome wall 821 and move protrusion 841 out of aperture 817 and into track 819, which helps to reduce if not eliminate inadvertent turning of first container 810 with respect to second container 830, which could cause at least a portion of openings 872 and 902 to overlap and prematurely or unintentionally release at least some of the content within internal area 815 of first container into the internal area 833 of second container 830. Additionally, another aperture similar to aperture 817 can be adjacent to the opposite end of track 819 to lock first container 810 in a fully opened position.

When it is desired to mix the contents of first container 810 with the contents of second container 830, first container (already received within channel 837) is turned by the user to at least partially align apertures 872 and 902 which causes the contents of first container 810 to travel through apertures 872 and 902 and into internal area 833 of second container for contact with the contents of second container 830 and to allow the two previously separate contents to be mixed together.

Once mixed, the combined contents can be exited out of either container by various types of mechanisms. As shown in the drawings, a brush 819 can be connected to a top portion 812 of first container 810. Brush 819 can comprise bristles 822 and base portion 820. Top portion 812 can be opened at its top end or an aperture in communication with a conduit to path to bristles 822 can be provided in the top portion. However, any conventional mechanism for get the mixed contents from within the containers to bristles 822 can be provided and all are considered within the scope of the invention. A cover cap 824 can also be provided at top portion 812 and protects bristles 822 when not in use.

Additionally or alternatively, after mixing first container 810 is removed and the combined contents stored in internal area 833 of second container 830 can be poured out of internal area 833 into a bowl or other object. In one embodiment, a bowl/dish or other object 832 can be removably secured to bottom portion 835 of second container 830. Furthermore, top portion 834, which defines channel 837, can be used as a pouring guide for the mixed contents exiting out of aperture 902.

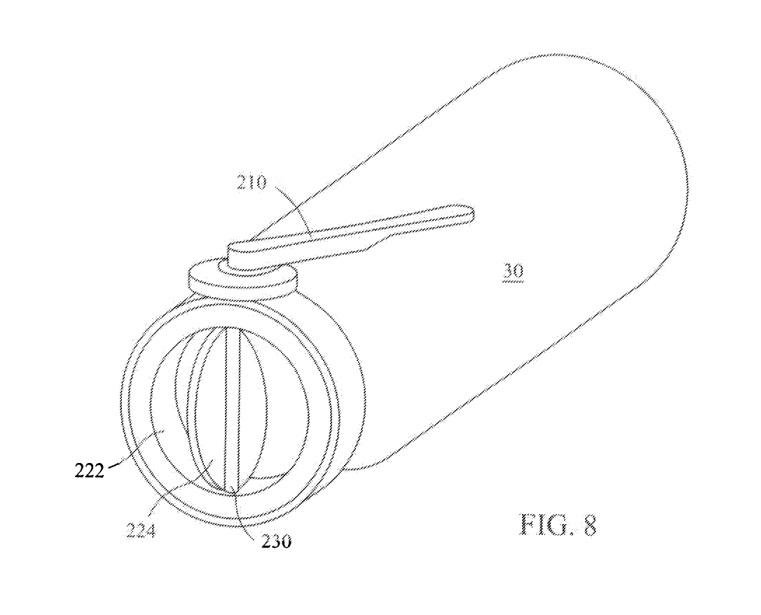

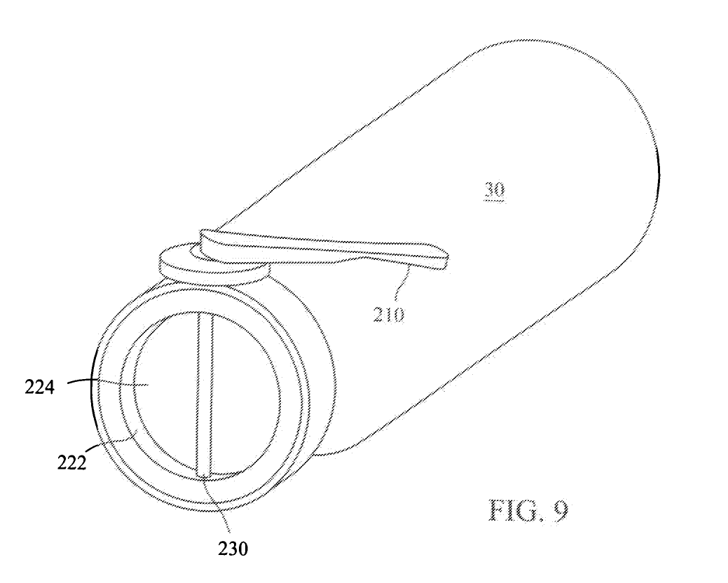

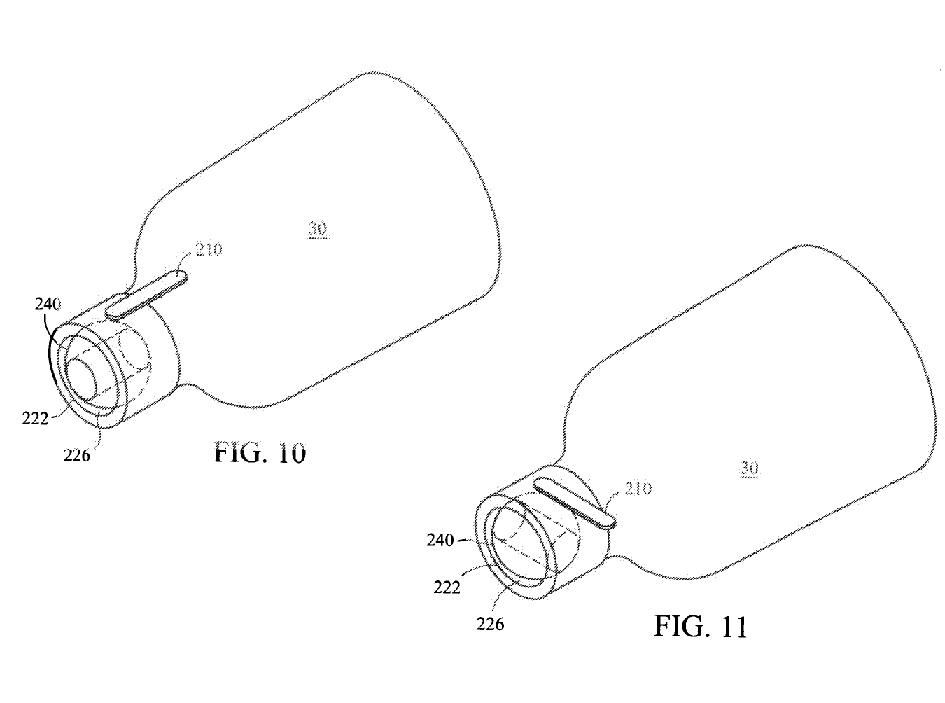

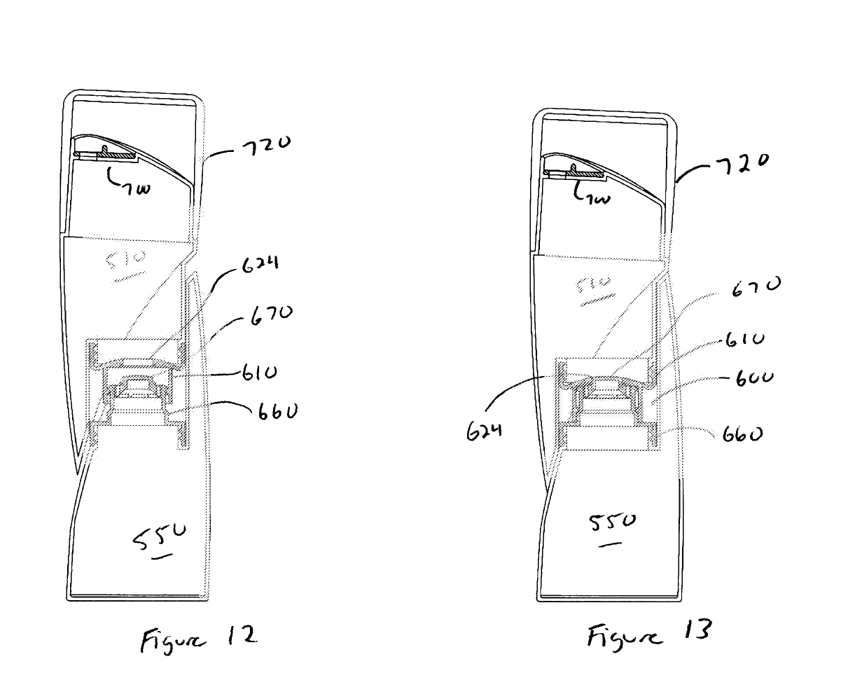

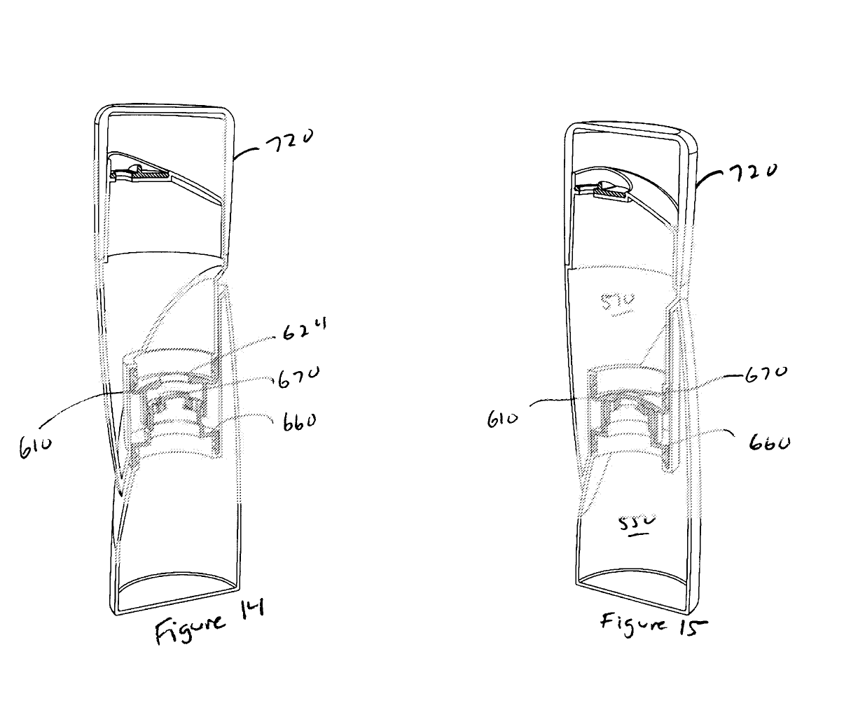

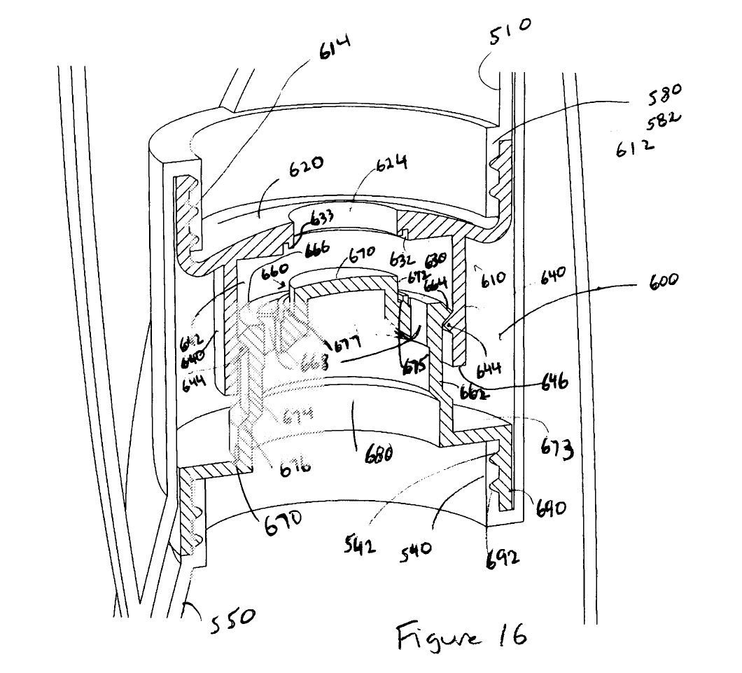

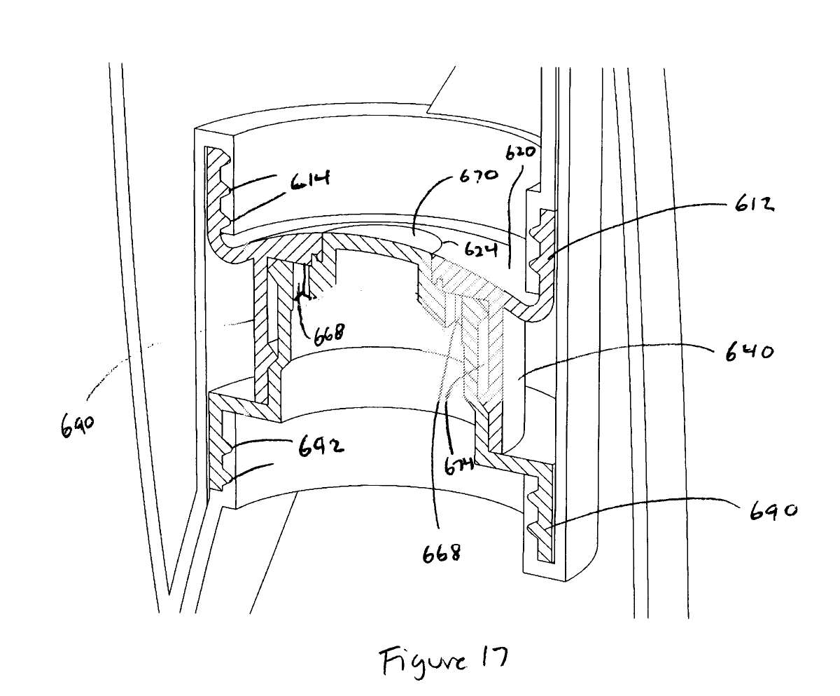

FIGS. 7 through 11 illustrate a third separating/mixing mechanism embodiment for the present invention which is generally reference at numeral 200. Mechanism 200 can include an intermediate member 220 which is disposed (removably or permanently) between the openings of containers 20 and 30. Internally disposed within intermediate 220 is a movable blocking member which in a first version (FIGS. 8 and 9) includes a plate-like member 224 and in a second version includes a ball-like member 240. Plate 224 and ball 240 are controlled by and connected to an externally exposed lever or handle 210.

For the first version, in a blocking/separating configuration, plate 224 is positioned as shown in FIG. 9, which seals internal communication between containers 20 and 30. To permit internal communication between the containers and thus the mixing of their respective stored contents, lever 210 is turned either clockwise or counterclockwise causing the plate 244 to correspondingly move (or rotate) around post 230 disposed within passageway of 222 of intermediate member 220. Thus, the movement of plate 224 and the opening of the passageway 222 permit internal communication between the containers 20 and 30 and their stored contents to be brought together.

For the second version of the blocking/mixing mechanism 200, ball 240 can be provided with an internal passageway 242 extending therethrough. In a sealed/closed configuration, passageway 242 of ball 240 is positioned by level 210 such that it is adjacent wall area 226 of intermediate member 220. Thus, no internal communication is provided between containers 20 and 30 as the main surface of ball 240 closes passageway 222. By turning lever 210, ball 240 moves correspondingly within passageway 222, and can align ball passageway 242 co-axially or substantially parallel, with passageway 222, such that an internal opening is provided between containers 20 and 30 to their respective stored contents to be mixed or brought together (see FIG. 10).

Apertures 102 and 110 can be various shapes and/or sizes to accommodate different substances.

Containers 20 and 30 can be constructed of various types of materials, including plastics and polymers, and are not limited to any particular material and all materials are considered within the scope of the invention. Furthermore, the material used for the plate 224 and/or ball 240 can be metal, steel, brass, precious metals, aluminum, non-metal, plastic, polymers, etc. and all materials are considered within the scope of the invention. Additionally, it is not a requirement that the separated contents in containers 20 and 30 be mixed together and it is within the scope of the invention that the previously stored and separated contents are merely brought together in one location.

It should also be recognized that the term “container” or “containers” as used herein can also include, pouches, sachets, sacks, boxes, canisters, and cartons. Furthermore, the containers can be quickly attached to and detached from each other such as, but not limited to, through a garden hose to water spicket type connection. Alternatively, the containers can be quickly attached to and detached from an intermediate member that houses the separating/mixing member.

Though the containers are shown disposed in linear relationship to each other, such is not considering limiting. Accordingly, it is considered within the scope of the invention that the containers be acquired or provided as a unit or double (side by side) pack. The double (side by side) pack can be attached together prior to usage.

Thus, the central mixing/separating valve mechanism of the present invention can provided in several different embodiments, including but not limited to, activation through twisting On/Off, Pull & Push On/Off, Turning a Leaver, Switch, Knob On/Off, or connecting Canister “A” to Canister “B” with a quick connect devise (similar to a garden hose). For purposes of the description and claims the term “valve” is used to describe any of the content mixing/separating mechanism.

As determined necessary various sealing mechanisms (o-rings, gaskets, sealants, etc.) can also be incorporated into the various embodiments of the present invention to further help to prevent or at least reduce inadvertent leakage of any fluid(s) stored within either container.

It will be seen that the objects set forth above, and those made apparent from the foregoing description, are efficiently attained and since certain changes may be made in the above construction without departing from the scope of the invention, it is intended that all matters contained in the foregoing description shall be interpreted as illustrative and not in a limiting sense. The instant invention has been shown and described herein in what is considered to be the most practical and preferred embodiment.

What is claimed is:

1. A device for storing multiple contents separately from each other until it is desired to mix the multiple contents together, comprising:
a first container having a first internal area for housing a first content;
a second container having a second internal area for housing a second content; and
valve means for isolating the first internal area from the second internal in a closed position and for providing communication between said first internal area and said second internal area in an opened position.

2. The device of claim 1 wherein in an opened position of said valve means the first content and the second content are permitted to be mixed together.

3. The device of claim 1 wherein either said first container or said second container provided with an outlet for exiting the mixed together first content and second content.

4. The device of claim 1 wherein said valve means comprising:
a first valve section having a first body member secured to the first container, said first body member having a lower sidewall defining a channel, said lower sidewall terminating at an end surface, said end surface having an aperture in communication with said channel, said sidewall having an inner protrusion extending into the channel, said first valve section in communication with the first internal area of said first container;
a second valve section having a second body member secured to the second container, said second body member having a top surface with an insertion member protruding upward from the top surface, said second body member having an outer protrusion, said second body member having a sidewall extending downward from said outer protrusion and having an outer surface, said top surface having one or more apertures extending therethrough, said second valve section in communication with the second internal area of said second container;
wherein said lower sidewall having an inner surface between said inner protrusion and said end surface and said outer protrusion disposed between said inner protrusion and said end surface;
wherein in an valve closed position said second valve section is positioned such that said insertion member is disposed within the end surface aperture and in a valve fully opened position said insertion member is positioned out of said end surface aperture causing said first valve section to be in internal communication with said second valve section which permits the first content disposed in the first internal area to be mixed with the second content disposed in the second internal area.

5. The device of claim 4 wherein in said valve closed position said top surface of said second valve section abuts said end surface.

6. The device of claim 4 wherein said first valve section defines a first groove/wall member disposed around the perimeter of said end surface aperture and said second valve section defines a second groove/wall member disposed around the perimeter of said insertion member, wherein in a valve fully closed position, said first groove/wall member and said second groove/wall member interlock.

7. The device of claim 5 wherein said first valve section defines a first groove/wall member disposed around the perimeter of said end surface aperture and said second valve section defines a second groove/wall member disposed around the perimeter of said insertion member, wherein in a valve fully closed position, said first groove/wall member and said second groove/wall member interlock.

8. The device of claim 4 wherein said first valve section having a base member having one or more outer threads which mate with one or more inner threads of said first container when said first valve section is secured to said first container.

9. The device of claim 4 wherein said second valve section having a base member having one or more outer threads which mate with one or more inner threads of said second container when said second valve section is secured to said second container.

10. The device of claim 4 wherein said outer protrusion of said second valve section contacting the inner surface of said lower sidewall when said first valve section is connected to said second valve section.

11. The device of claim 3 further comprising means for opening and closing the outlet on either said first container or said second container having an aperture.

12. The device of claim 4 wherein said valve means comprising:
a first valve section comprising a lower portion formed or incorporated into the first container to define a first passageway which is in communication with the first internal area of said first container;
a second valve section comprising a ledge surface formed or incorporated into the second container to define a second passageway which is in communication with the second internal area of said second container;
wherein in a fully closed valve position said lower portion is aligned with the second passageway and said ledge surface is aligned with the first passageway and in a fully opened valve position said first passageway is aligned with said second passageway which permits the first content disposed in the first internal area to be mixed with the second content disposed in the second internal area.

13. The device of claim 1 wherein said second container defining a receiving area for receipt of a portion of said first container.

14. The device of claim 13 wherein a lower area of said first container having an outer protrusion extending out from said first container and said receiving area having a groove; wherein said outer protrusion is disposed within said groove when said first container is properly received within said receiving area of said second container.

15. The device of claim 13 wherein said lower portion of said first container having an aperture and track and said receiving area having an inwardly extending protrusion; wherein said inwardly extending protrusion is disposed in said aperture to lock said first container in a fully closed valve position with respect to said second container.

16. The device of claim 15 wherein said inwardly extending protrusion is disposed within said track when said first container is in a fully or partially opened valve position with respect to said second container.

17. The device of claim 4 wherein said valve means comprising:
a body member secured to said first container and to said second container;
a blocking element pivotally connected to the body member and in a fully closed position said blocking element prevents communication between the first internal area and the second internal area and in a fully or partially opened position said blocking element permits communication between the first internal area and the second internal area; and
means for moving said blocking element from the fully closed position to the fully opened position or any position between the fully closed position and fully opened position.

18. The device of claim 17 wherein said means for moving is an externally accessible lever operatively connected to said blocking element.

19. A method for storing multiple contents separately from each other unit it is desired to mix the multiple contents together, said method comprising the steps of:
(a) providing a first container housing a first content within its first internal area;
(b) providing a second container housing a second content within its second internal area;
(c) providing a valve between the first internal area and the second internal area;
(d) isolating the first content from the second content during storage by placing the valve in a closed position; and
(e) mixing the first content with the second content by placing the valve in an at least partially opened position to provide communication between the first internal area and the second internal area.

20. The method of claim 19 further comprising the step of providing an outlet on either the first container or second container for exiting the mixed first and second contents.
